(19) United States
(12) Patent Application Publication
(10) Pub. No.: US 2020/0300466 A1
(43) Pub. Date: Sep. 24, 2020

(54) FUEL TREATMENT SYSTEM, AND FUEL TREATMENT METHOD

(71) Applicant: VHC HOLDING B.V., Tilburg (NL)

(72) Inventor: Robertus Johannes Antonius VERHOOF, Minderhout (BE)

(21) Appl. No.: 16/755,327

(22) PCT Filed: Nov. 8, 2018
(86) PCT No.: PCT/NL2018/050745

§ 371 Date: Apr. 10, 2020

(30) Foreign Application Priority Data
Nov. 8, 2017 (NL) 1042635

(51) Int. Cl. F23K 5/08; F23K 5/18; F02M 37/00; F02M 37/22; B03C 1/30

(52) U.S. Cl. CPC F23K 5/08; F23K 5/18; F02M 37/0058; F23K 2900/05141; B03C 1/30; F23K 2300/101; F23K 2300/202; F02M 37/22

(57) ABSTRACT

A fuel treatment system for effecting reduced emissions when combusting the fuel comprises a fuel treatment device comprising an inlet connectable to a main fuel tank and an outlet for supplying treated fuel. The fuel treatment device comprises a treatment section between said inlet and outlet, and a pump for pumping the fuel from said inlet through the treatment section to said outlet. A manifold device has an inlet connected to the outlet of the fuel treatment device, and a first outlet connectable to a fuel consumption device for supplying the treated fuel thereto. A first recirculation line connects a second outlet of the manifold device and the inlet of the fuel treatment device for recirculating treated fuel from the manifold device to the fuel treatment device.

The invention relates to the field of fuel treatment systems and methods, in particular to fuel treatment systems and methods for effecting reduced emissions when combusting the fuel.

### BACKGROUND OF THE INVENTION

In atmospheric chemistry, NOx is a generic term for the nitrogen oxides that are most relevant for air pollution, namely nitric oxide (NO) and nitrogen dioxide (NO₂). These gases contribute to the formation of smog and acid rain, as well as tropospheric ozone.

In areas of high motor vehicle traffic, such as in large cities, soot and nitrogen oxides emitted by vehicle engines can be a significant source of air pollution. Here, soot comprises unburned hydrocarbon particles, whereas CO₂ is the natural product of burning hydrocarbons. Other big contributors to soot and NOx production are ships, which often rely on highly polluting diesel engines.

From an environmental point of view, the emission of soot, NOx and CO₂ may thus be seen as undesirable. The inventor recognized that there is a need in the field for cleaner emissions when combusting fuels, wherein soot, NOx and CO₂ are reduced. It is noted that CO₂ reductions can be achieved by a more effective combustion, reducing a fuel consumption rate.

A solution to providing cleaner emissions is to treat the fuel before combustion. Treating the fuel often entails subjecting the fuel to a filter, wherein large particles are removed from the fuel. Although subjecting fuel to a filter before combustion reduces emissions, the level of reduction has not been satisfying.

Another solution may be to subject the fuel to a higher number of filters. A disadvantage of such a solution is that it leads to a larger system. As space is often limited in engine rooms of ships or vehicles, a compact system is desired.

Yet another solution to reducing emissions is to provide a water emulsion system, which mixes the fuel with water before combustion. Although this reduces emissions, it is considered an expensive solution, for it requires a costly device and a constant supply of water to be carried in a water tank.

### SUMMARY OF THE INVENTION

It would be desirable to provide a fuel treatment system and method providing cleaner emissions when the fuel is subsequently combusted. It would further be desirable to provide a fuel treatment system and method which is cost effective, while providing cleaner emissions. It would yet further be desirable to provide a fuel treatment system and method which is space efficient, while providing cleaner emissions.

To better address one or more of these concerns, in a first aspect of the invention a fuel treatment system is provided, comprising:

a fuel treatment device comprising an inlet configured to be in fluid communication with a main fuel tank for receiving original fuel from the main fuel tank, an outlet for supplying treated fuel, wherein the fuel treatment device comprises a treatment section between the inlet and the outlet of the fuel treatment device, and a pump for pumping the fuel from the inlet of the fuel treatment device through the treatment section to the outlet of the fuel treatment device; and

a manifold device having an inlet configured to be in fluid communication with the outlet of the fuel treatment device for receiving treated fuel from the fuel treatment device, and a first outlet configured to be in fluid communication with a fuel consumption device for supplying the treated fuel to the fuel consumption device,

wherein the fuel treatment system further comprises:

a first recirculation line configured for fluid communication between a second outlet of the manifold device and the inlet of the fuel treatment device, for recirculating the treated fuel from the manifold device to the fuel treatment device, and through the fuel treatment device to the manifold device, wherein no treated fuel is supplied to the main fuel tank from the inlet of the fuel treatment device.

An advantage of the fuel treatment system is that the treated fuel may be treated multiple times through recirculation, such that the fuel treatment system in fact acts as a multi-pass system. Treating the already treated fuel a second time, and further times, results in cleaner fuel, which in turn leads to cleaner emissions when combusting the fuel. Treated fuel may be recirculated multiple times, wherein each recirculating results in cleaner fuel.

Another advantage of the fuel treatment system is that it is compact, as the first recirculation line allows for a high number of fuel treatments, while providing merely one treatment section in the fuel treatment device.

As the first recirculation line allows for multi-pass fuel treatment, the fuel treatment system provides a cost effective solution, as merely one treatment section in the fuel treatment device of the fuel treatment system is required. In order to obtain a same level of fuel treatment without providing a first recirculation line, a larger number of fuel treatment sections would be required. Such a system would therefore be disadvantageous from a space and cost point of view.

In an embodiment of the fuel treatment system, the manifold device is a reservoir, or comprises a reservoir.

The reservoir may be embodied as a pipe with closed ends, or as an accumulator.

The fuel consumption device may be a fuel combustion device for combusting the fuel, such as an engine. In another embodiment, the fuel consumption device may be a tank or fuel container for storage of treated fuel. The fuel consumption device may comprise different devices together consuming the treated fuel.

In an embodiment of the fuel treatment system, the reservoir accumulates N (N greater than 1) times treated fuel.

In an embodiment of the fuel treatment system, N is determined by a ratio between a flow rate of the pump and a fuel consumption rate, in particular a dynamic fuel consumption rate, of the fuel consumption device. When the fuel consumption rate is known, the pump flow rate may be adapted such that it is N times the fuel consumption rate. This way, the treated fuel is recirculated as many times as desired, though limited by the pump capacity of the pump. In an embodiment of the fuel treatment system, the pump flow rate is at least two times as high as the fuel consumption rate, in particular a mean or a maximum fuel consumption rate, of the fuel consumption device, such that N is at least 2. Preferably, N is at least 3.

In an embodiment of the fuel treatment system, the treatment section comprises at least one magnetic treatment unit configured for subjecting the fuel to a magnetic field.

In an embodiment of the fuel treatment system, the treatment section comprises at least one particle removal device such as a filter, a separator, or a membrane, or a sieve or any combination thereof.

In an embodiment of the fuel treatment system, the treatment section comprises at least one magnetic treatment unit, and at least one particle removal device.

The magnetic treatment unit provides the magnetic field. Due to the magnetic field, negatively and positively charged particles inside the fuel, which disadvantageously are clustered, become separated. As separated particles have a higher total surface area compared to the clusters, the separation, and thus the magnetic treatment unit, has a positive effect on the fuel consumption rate. During combustion of the fuel, the fuel having undergone a magnetic field treatment may be burned more completely.

In an embodiment of the fuel treatment system, the system comprises at least one particle removal device located downstream of the magnetic treatment unit. As a result of the magnetic treatment of the fuel in the magnetic treatment unit, previously clustered particles have become separated from each other, whereby the downstream particle removal device, in particular a filter or a membrane, is able to operate more efficiently.

In an embodiment of the fuel treatment system, the system comprises at least one particle removal device located upstream of the magnetic treatment unit. The upstream particle removal device may be configured to remove larger particles from the fuel, thereby increasing the effectiveness of the magnetic treatment in the magnetic treatment unit for smaller particles not removed from the fuel by the upstream particle removal device.

In some embodiments of the fuel treatment system, the system comprises both a particle removal device upstream of the magnetic treatment unit and a particle removal device downstream of the magnetic treatment unit.

In an embodiment of the fuel treatment system, the pump is located upstream of the treatment section. Advantageously, in such embodiment possible pollutants introduced into the fuel by the pump, e.g. due to wear, may be removed from the fuel in the treatment section.

In some embodiments, a water separator may be located upstream or downstream of the pump.

In an embodiment, the fuel treatment system further comprises a tank fluid line configured to extend from the inlet of the fuel treatment device to the main fuel tank, wherein the tank fluid line comprises a first one-way valve configured to allow a flow of original fuel from the main fuel tank to the inlet of the fuel treatment device, and to block a reverse flow. The first one-way valve ensures that treated fuel recirculated through the first recirculation line is introduced into the fuel treatment device for a further treatment, and cannot pass into the main fuel tank.

In an embodiment, the fuel treatment system further comprises a back pressure valve in the first recirculation line, wherein the back pressure valve is configured to allow a flow of treated fuel from the manifold device to the inlet of the fuel treatment device, and to block a reverse flow. The back pressure valve ensures that no fuel can pass into the manifold device untreated by the fuel treatment device.

In an embodiment, the fuel treatment system further comprises a safety fluid line configured to extend from a third outlet of the manifold device to the main fuel tank, wherein the safety fluid line comprises a pressure safety valve configured to allow a flow of treated fuel from the manifold device to the main fuel tank if a pressure of the fuel in the manifold device exceeds a predetermined threshold pressure. The pressure safety valve opens in case the pressure in the manifold device becomes too high, e.g. in case the pump power is (too) high with respect to a flow resistance in the fuel treatment system.

In an embodiment, the fuel treatment system further comprises:

a detector configured and arranged to detect a property of the treated fuel supplied from the manifold device to the fuel consumption device, or to the first recirculation line, and to supply a corresponding detector signal; and

a controller configured to control the pump flow rate based on the detector signal.

The detector may be arranged in the manifold device, in the fuel consumption device, or in the first recirculation line, as appropriate.

The controller, receiving the detector signal indicating a value of the property, controls the pump flow rate for the property to be in a particular range, or near or at a particular value. An example of a property of the treated fuel is the concentration of particles, wherein the detector may be configured and arranged to detect a number of particles per unit of time flowing in a line from the manifold device to the fuel consumption device. As an example, if the number of particles exceeds a desired threshold, the pump flow rate may be increased to increase the recirculation of treated fuel to the fuel treatment device, to remove more particles from the fuel in the fuel treatment device. As a result, the number of particles may be lowered to below the threshold.

In an embodiment of the fuel treatment system, the detector is configured and arranged to measure the fuel consumption rate of the fuel consumption device, and the controller is configured to control the pump flow rate proportional to the fuel consumption rate. As an example, if the fuel consumption rate is relatively low, the pump flow rate may be controlled to be relatively low, whereas if the fuel consumption rate increases, the pump flow rate may be controlled to be increased, whereby an appropriate treatment of the fuel in the fuel treatment device may be obtained in all circumstances of fuel consumption.

In an embodiment of the fuel treatment system, the detector is configured and arranged to measure a particle size of particles in the treated fuel, and the controller is configured to control the pump flow rate proportional to the particle size.

If the fuel consumption rate is low, then the pump flow rate may also be lower, as recirculating the treated fuel requires power as well. Also, if the particle size, or mean particle size, of particles in the treated fuel is below a predetermined size, then the pump flow rate may also be lower.

The controller provides flexibility, which is beneficial from an efficiency perspective. Controlling the number N of recirculation provides an optimum pump power consumption, while maintaining the result of cleaner emissions.

In practice, it is known that engines, in particular diesel engines, embodying the fuel consumption device, return unburned fuel to the main fuel tank, which contains original, untreated fuel. Thus, in the main fuel tank, an undesired mixing of original fuel and treated fuel occurs, whereby a treatment efficiency is lowered.

Conversely, in an advantageous embodiment of the fuel treatment system, a second recirculation line, a third recirculation line, and/or a fourth recirculation line are configured for fluid communication between (a return output of) the fuel consumption device and the manifold device, the first recirculation line, and/or the inlet of the fuel treatment device, respectively, for recirculating the treated fuel from the fuel consumption device to the fuel treatment device.

In an embodiment of the fuel treatment system, the second, third, and/or fourth recirculation lines may comprise a corresponding second, third, and/or fourth one-way valve.

An advantage of recirculating the treated fuel returned from the fuel consumption device to either the manifold device, the first recirculation line, and/or the inlet of the fuel treatment device, is that the treated fuel is maintained in the fuel treatment system, resulting in higher quality treated fuel.

In a second aspect of the invention, a method is provided of treating fuel for effecting reduced emissions when combusting the fuel, the method comprising:

supplying original fuel from a main fuel tank through a fuel treatment device to a manifold device, wherein the manifold device receives treated fuel;

supplying the treated fuel from the manifold device to a fuel consumption device,

wherein the method further comprises:

recirculating the treated fuel from the manifold device through the fuel treatment device to the manifold device, wherein no treated fuel is supplied to the main fuel tank.

In an embodiment of the fuel treatment method, the manifold device comprises a reservoir, and wherein the reservoir accumulates N (N greater than 1) times treated fuel.

In an embodiment of the fuel treatment method, the fuel treatment device comprises a pump, and N is determined by a ratio between a flow rate of the pump and a fuel consumption rate of the fuel consumption device.

In an embodiment of the fuel treatment method, the pump flow rate is at least two times as high as the fuel consumption rate, in particular a mean or a maximum fuel consumption rate, of the fuel consumption device. Preferably, the pump flow rate is at least three times as high as the fuel consumption rate, in particular the mean or the maximum fuel consumption rate, of the fuel consumption device.

In an embodiment, the fuel treatment method further comprises, in the fuel treatment device:

subjecting the fuel to a magnetic field; and/or

removing particles from the fuel.

In an embodiment of the fuel treatment method, the magnetic field subjecting step is performed before the particle removing step.

In an embodiment of the fuel treatment method, a further particle removing step is performed before the magnetic field subjecting step.

In an embodiment, the fuel treatment method further comprises:

allowing a flow of original fuel from the main fuel tank to the inlet of the fuel treatment device, and blocking a reverse flow.

In an embodiment, the fuel treatment method further comprises:

allowing a flow of treated fuel from the manifold device to the inlet of the fuel treatment device, and blocking a reverse flow.

In an embodiment, the fuel treatment method further comprises:

allowing a flow of treated fuel from the fuel consumption device to the inlet of the fuel treatment device, or to the manifold device.

In an embodiment, the fuel treatment method further comprises:

if a pressure of the fuel in the manifold device exceeds a predetermined threshold pressure, allowing a flow of treated fuel from the manifold device to the main fuel tank, and blocking a reverse flow.

In an embodiment, the fuel treatment method further comprises:

determining a property of the treated fuel supplied from the manifold device to the fuel consumption device or to the fuel treatment device, and, based on the property, controlling the pump flow rate.

These and other aspects of the invention will be more readily appreciated as the same becomes better understood by reference to the following detailed description and considered in connection with the accompanying drawings in which like reference symbols designate like parts.

### BRIEF DESCRIPTION OF THE FIGURE

FIG. 1 schematically shows a block diagram of an embodiment of a fuel treatment system according to the present invention.

### DETAILED DESCRIPTION OF THE FIGURE

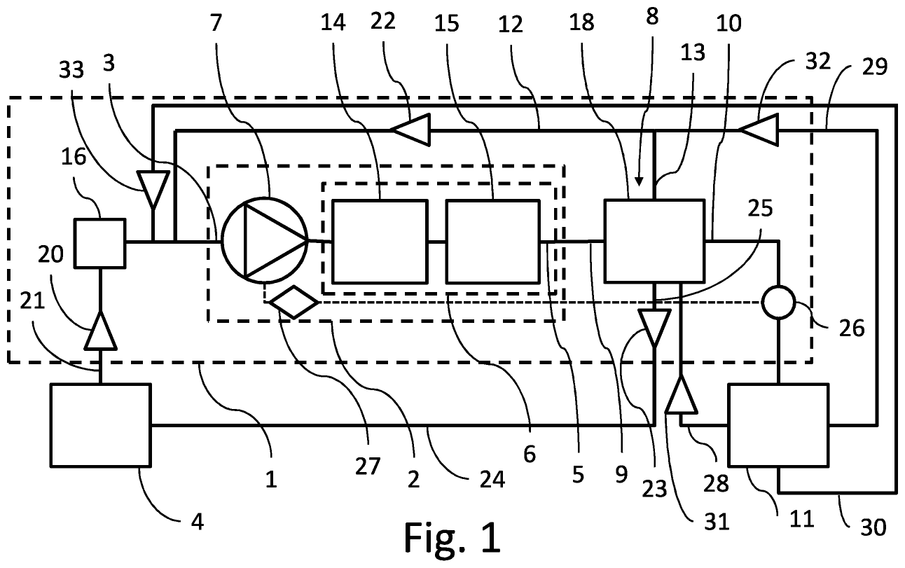

FIG. 1 shows a block diagram of an example embodiment of a fuel treatment system 1 (as indicated by a dashed line) for treating fuel, to effect reduced NOx emissions when combusting the fuel. The fuel treatment system 1 comprises a fuel treatment device 2 (as indicated by a dashed line). The fuel treatment device 2 has an inlet 3 which is configured to be in fluid communication with a main fuel tank 4 for receiving original fuel from the main fuel tank 4. The fuel treatment device 2 further has an outlet 5 for supplying treated fuel, i.e. fuel that has been treated in the fuel treatment device 2. The fuel treatment device 2 has a treatment section 6 between the inlet 3 and the outlet 5 of the fuel treatment device 2. The fuel treatment device 2 further comprises a pump 7 for pumping the fuel from the inlet 3 of the fuel treatment device 2 through the treatment section 6 to the outlet 5 of the fuel treatment device 2.

A manifold device 8 is provided having an inlet 9 configured to be in fluid communication with the outlet 5 of the fuel treatment device 2. The manifold device 8 is configured for receiving treated fuel from the fuel treatment device 2. The manifold device 8 further has a first outlet 10 configured to be in fluid communication with a fuel consumption device 11, such as an engine, for supplying the treated fuel to the fuel consumption device 11. The manifold device in FIG. 1 is a reservoir 18.

A first recirculation line 12 is provided configured for fluid communication between a second outlet 13 of the manifold device 8 and the inlet 3 of the fuel treatment device 2. The first recirculation line 12 allows recirculation of the treated fuel from the manifold device 8 to the fuel treatment device 2. Due to the recirculation of the treated fuel, the reservoir 18 accumulates N (N greater than 1) times treated fuel. No treated fuel is supplied to the main fuel tank 4 from the inlet 3 of the fuel treatment device 2. This prevents dilution of treated fuel by the original fuel in the main fuel tank 4.

N may be determined by a ratio between a flow rate of the pump 7 and a fuel consumption rate of the fuel combustion device 11. For example, an N of 3 entails a flow rate of the pump 7 which is three times as high as the fuel consumption rate of the fuel consumption device 11. A high N is desired from an environmental point of view, since multiple recirculations of treated fuel lead to cleaner fuel, which in turn leads to cleaner emissions and lower fuel consumption. N may relate to the mean or maximum fuel consumption rate of the fuel consumption device 11 and/or duration thereof. A size of volume of the reservoir 18 is adapted accordingly. The fuel consumption device 11 may comprise different devices together consuming the treated fuel.

The treatment section 6 in FIG. 1 may comprise a magnetic treatment unit 14 configured for subjecting the fuel to a magnetic field. The treatment section 6 further comprises a particle removal device 15. The particle removal device 15 may be a sieve, a filter, a separator, a centrifuge, a membrane, or any combination thereof. In the following description, the particle removal device 15 is constituted by a filter. It is also possible to provide multiple magnetic treatment units 14 and filters 15 in the treatment section 6. In the shown embodiment, the magnetic treatment unit 14 is located upstream of the filter 15, and the pump 7 is located upstream of the magnetic treatment unit 14. Such an arrangement is beneficial, because due to the magnetic treatment prior to filtering, the fuel which enters the filter 15 comprises particles with a reduced particle size. When clustered particles would enter the filter 15, the filter 15 tends to have a shorter lifespan, because the clustered particles would not pass the filter 15, thereby clogging the filter 15.

Other arrangements of the treatment device 2 are also possible. The magnetic treatment unit 14 and the filter 15 may be placed either upstream or downstream of the pump 7, and the filter 15 may be placed upstream of the magnetic treatment unit 14. It is also possible to arrange the filter 15 and/or the magnetic treatment unit 14 inside the reservoir 18, such that an integrated filter-reservoir unit, and integrated magnetic treatment unit-reservoir, or an integrated filter-magnetic treatment unit-reservoir is obtained.

A tank fluid line 21 extends from the inlet 3 of the fuel treatment device 2 to the main fuel tank 4. The tank fluid line 21 comprises a first one-way valve 20 which is configured to allow a flow of original fuel from the main fuel tank 4 to the inlet of the fuel treatment device 2, and to block a reverse flow. The tank fluid line 21 may further comprise at least one of a particle removal device, a water separation device, a water mixing device, and an additive mixing device, indicated by 16.

A back pressure valve 22 is provided in the first recirculation line 12, between the manifold device 8 and the inlet 3 of the fuel treatment device 2. The back pressure valve 22 is configured to allow a flow of treated fuel from the manifold device 8 to the inlet 3 of the fuel treatment device 2, and to block a reverse flow. It also provides a pressure in manifold device 8 to improve the flow of treated fuel to the fuel consumption device 11.

A safety fluid line 24 extends from a third outlet 25 of the manifold device 8 to the main fuel tank 4. The safety fluid line 24 comprises a pressure safety valve 23 which is configured to allow a flow of treated fuel from the manifold device 8 to the main fuel tank 4 if a pressure of the fuel in the manifold device 8 exceeds a predetermined threshold pressure. It may serve as a safety line or back-up with respect to the first recirculation line 12, which first recirculation line 12 is configured to allow treated fuel to exit the manifold device through outlet 13. However, if the pressure inside the manifold device 8 would become higher than a predetermined threshold pressure determined by the pressure safety valve 23, treated fuel may also exit the manifold device 8 via the safety fluid line 24.

A second recirculation line 28 is in fluid communication between an output of the fuel consumption device 11 and the manifold device 8. The second recirculation line 28 may comprise a corresponding second one-way valve 31, which only allows a flow from the fuel consumption device 11 to the manifold device 8.

A third recirculation line 29 is in fluid communication between the fuel consumption device 11 and the first recirculation line 12. The third recirculation line 29 may comprise a corresponding third one-way valve 32, which only allows a flow from the fuel consumption device 11 to the first recirculation line 12.

A fourth recirculation line 30 is in fluid communication between the fuel consumption device 11 and the inlet 3 of the fuel treatment device 2. The fourth recirculation line 30 may comprise a corresponding fourth one-way valve 33, which only allows a flow from the fuel consumption device 11 to the inlet 3 of the fuel treatment device 2.

The second 28, third 29, and fourth 30 recirculation lines allow the treated fuel which is not used by the fuel consumption device 11 to be recirculated to, and through the fuel treatment system 1. This results in even cleaner treated fuel, and thus cleaner emissions. The treated fuel does not flow from the fuel consumption device 11 to the main fuel tank 4. The treated fuel which is recirculated may be cooled after exiting the fuel consumption device 11, because this treated fuel tends to be hot. Generally, only one of these three recirculation lines 28, 29, 30 may be provided.

The fuel treatment system 1 may comprise a detector 26. The detector 26 is configured and arranged to detect a property of the treated fuel which is supplied from the manifold device 8 to the fuel consumption device 11. A corresponding detector signal is then supplied by the detector 26 to a controller 27, as indicated by a dashed line between the detector 26 and the controller 27. The controller 27 is configured to control the pump flow rate of the pump 7 based on the detector signal, as indicated by a dashed line between the controller 27 and the pump 7.

The detector 26 may be configured and arranged to measure the fuel consumption rate of the fuel consumption device 11. In accordance with the measured fuel consumption rate, the controller 27 controls the pump flow rate of the pump 7 proportional to the measured fuel consumption rate.

The detector 26 may also be configured and arranged to measure a particle size of particles in the treated fuel. In accordance with the measured particle size, the controller 27 controls the pump flow rate of the pump 7 proportional to the particle size.

It is also possible to provide a pressure sensor in the fuel treatment system, which can be used to identify filter blocking. Such a pressure sensor may be provided upstream of the filter. When the pressure upstream of the filter increases above a predetermined threshold value, the pressure sensor notices this and supplies a corresponding signal to a receiving station. An operator will be alerted and will check and/or replace the filter.

As explained in detail above, a fuel treatment system for effecting reduced NOx, CO₂ and/or soot emissions when combusting the fuel comprises a fuel treatment device comprising an inlet connectable to a main fuel tank and an outlet for supplying treated fuel. The fuel treatment device comprises a treatment section between said inlet and outlet, and a pump for pumping the fuel from said inlet through the treatment section to said outlet. A manifold device 8 has an inlet connected to the outlet of the fuel treatment device, and a first outlet connectable to a fuel consumption device for supplying the treated fuel to the fuel consumption device. A first recirculation line connects a second outlet of the manifold device and the inlet of the fuel treatment device for recirculating treated fuel from the manifold device to the fuel treatment device.

It is to be understood that the invention entails the fuel treatment system of the present invention. It may be the case that when such a fuel treatment system is installed on for example a ship, certain components of the fuel treatment system are already present on such a ship. A pump is such a component that may already be present in the existing fuel supply system of the fuel consumption device. Then, the other components of the fuel treatment system of the present invention can be integrated in the existing fuel supply system using the already present pump.

As required, detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention. Further, the terms and phrases used herein are not intended to be limiting, but rather, to provide an understandable description of the invention.

The terms “a”/“an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

1. A fuel treatment system for effecting reduced emissions when combusting the fuel, the fuel treatment system comprising:
a fuel treatment device comprising an inlet configured to be in fluid communication with a main fuel tank for receiving original fuel from the main fuel tank, an outlet for supplying treated fuel, a treatment section between the inlet and the outlet of the fuel treatment device, and a pump for pumping the fuel from the inlet of the fuel treatment device through the treatment section to the outlet of the fuel treatment device; and
a manifold device having an inlet configured to be in fluid communication with the outlet of the fuel treatment device for receiving treated fuel from the fuel treatment device, and a first outlet configured to be in fluid communication with a fuel consumption device for supplying the treated fuel to the fuel consumption device,
wherein the fuel treatment system further comprises:
a first recirculation line configured for fluid communication between a second outlet of the manifold device and the inlet of the fuel treatment device, for recirculating the treated fuel from the manifold device to the fuel treatment device, and through the fuel treatment device to the manifold device, wherein no treated fuel is supplied to the main fuel tank from the inlet of the fuel treatment device.

2. The fuel treatment system according to claim 1, wherein the manifold device is a reservoir, or comprises a reservoir.

3. The fuel treatment system according to claim 2, wherein the reservoir accumulates N (N greater than 1) times treated fuel.

4. The fuel treatment system according to claim 3, wherein N is determined by a ratio between a flow rate of the pump and a fuel consumption rate of the fuel consumption device.

5. The fuel treatment system according to claim 1, wherein a pump flow rate is at least two times as high as a fuel consumption rate of the fuel consumption device.

6. The fuel treatment system according to claim 1, wherein the treatment section comprises at least one magnetic treatment unit configured for subjecting the fuel to a magnetic field.

7. The fuel treatment system according to claim 1, wherein the treatment section comprises at least one particle removal device.

8. The fuel treatment system according to claim 1, wherein the treatment section comprises at least one magnetic treatment unit and at least one particle removal device.

9. The fuel treatment system according to claim 8, comprising at least one particle removal device located downstream of the magnetic treatment unit.

10. The fuel treatment system according to claim 8, comprising at least one particle removal device located upstream of the magnetic treatment unit.

11. The fuel treatment system according to claim 7, wherein the particle removal device comprises a sieve, a filter, a separator, a centrifuge and/or a membrane.

12. The fuel treatment system according to claim 1, wherein the pump is located upstream of the treatment section.

13. The fuel treatment system according to claim 1, further comprising a tank fluid line configured to extend from the inlet of the fuel treatment device to the main fuel tank, wherein the tank fluid line comprises a first one-way valve configured to allow a flow of original fuel from the main fuel tank to the inlet of the fuel treatment device, and to block a reverse flow.

14. The fuel treatment system according to claim 1, further comprising a back pressure valve in the first recirculation line, wherein the back pressure valve is configured to allow a flow of treated fuel from the manifold device to the inlet of the fuel treatment device, and to block a reverse flow.

15. The fuel treatment system according to claim 1, further comprising a safety fluid line configured to extend from a third outlet of the manifold device to the main fuel tank, wherein the safety fluid line comprises a pressure safety valve configured to allow a flow of treated fuel from the manifold device to the main fuel tank if a pressure of the fuel in the manifold device exceeds a predetermined threshold pressure.

16. The fuel treatment system according to claim 1, further comprising:
a detector configured and arranged to detect a property of the treated fuel supplied from the manifold device to the fuel consumption device or to the first recirculation line, and to supply a corresponding detector signal; and
a controller configured to control the pump flow rate based on the detector signal.

17. The fuel treatment system according to claim 16, wherein the detector is configured and arranged to measure the fuel consumption rate of the fuel consumption device, and wherein the controller is configured to control the pump flow rate proportional to the fuel consumption rate.

18. The fuel treatment system according to claim 16, wherein the detector is configured and arranged to measure a particle size of particles in the treated fuel, and wherein the controller is configured to control the pump flow rate proportional to the particle size.

19. The fuel treatment system according to claim 1, wherein the fuel consumption device is an engine or a fuel container.

20. The fuel treatment system according to claim 1, wherein a second recirculation line, a third recirculation line, and/or a fourth recirculation line are configured for fluid communication between the fuel consumption device and the manifold device, the first recirculation line, and/or the inlet of the fuel treatment device, respectively, for recirculating the treated fuel from the fuel consumption device to the fuel treatment device.

21. The fuel treatment system according to claim 20, wherein the second, third, and/or fourth recirculation lines comprise a corresponding second, third, and/or fourth one-way valve.

22. A method of treating fuel for effecting reduced emissions when combusting the fuel, the method comprising:
supplying original fuel from a main fuel tank through a fuel treatment device to a manifold device, wherein the manifold device receives treated fuel;
supplying the treated fuel from the manifold device to a fuel consumption device; and
recirculating the treated fuel from the manifold device through the fuel treatment device to the manifold device, wherein no treated fuel is supplied to the main fuel tank.

23. The fuel treatment method according to claim 22, wherein the manifold device comprises a reservoir, and wherein the reservoir accumulates N (N greater than 1) times treated fuel.

24. The fuel treatment method according to claim 23, wherein the fuel treatment device comprises a pump, and wherein N is determined by a ratio between a flow rate of the pump and a fuel consumption rate of the fuel consumption device.

25. The fuel treatment method according to claim 24, wherein the pump flow rate is at least two times as high as the fuel consumption rate of the fuel consumption device.

26. The fuel treatment method according to claim 22, further comprising, in the fuel treatment device:
subjecting the fuel to a magnetic field.

27. The fuel treatment method according to claim 22, further comprising, in the fuel treatment device:
removing particles from the fuel.

28. The fuel treatment method according to claim 22, further comprising, in the fuel treatment device:
subjecting the fuel to a magnetic field; and
removing particles from the fuel.

29. The fuel treatment method according to claim 28, wherein the magnetic field subjecting step is performed before the particle removing step.

30. The fuel treatment method according to claim 28, wherein the particle removing step is performed before the magnetic field subjecting step.

31. The fuel treatment method according to claim 22, further comprising:
allowing a flow of original fuel from the main fuel tank to the inlet of the fuel treatment device, and blocking a reverse flow.

32. The fuel treatment method according to claim 22, further comprising:
allowing a flow of treated fuel from the manifold device to the inlet of the fuel treatment device, and blocking a reverse flow.

33. The fuel treatment method according to claim 22, further comprising:
allowing a flow of treated fuel from the fuel consumption device to the inlet of the fuel treatment device, or to the manifold device.

34. The fuel treatment method according to claim 22, further comprising:
if a pressure of the fuel in the manifold device exceeds a predetermined threshold pressure, allowing a flow of treated fuel from the manifold device to the main fuel tank, and blocking a reverse flow.

35. The fuel treatment method according to claim 22, further comprising:
determining a property of the treated fuel supplied from the manifold device to the fuel consumption device or to the fuel treatment device, and, based on the property, controlling the pump flow rate.
